(19) United States
(12) Patent Application Publication
(10) Pub. No.: US 2018/0319331 A1
(43) Pub. Date: Nov. 8, 2018

(54) VEHICLE LAMP

(71) Applicant: Ford Global Technologies, LLC, Dearborn, MI (US)

(72) Inventors: Stuart C. Salter, White Lake, MI (US); James J. Surman, Clinton Township, MI (US); Paul Kenneth Dellock, Northville, MI (US); Jeffrey Singer, Plymouth, MI (US)

(73) Assignee: Ford Global Technologies, LLC

(21) Appl. No.: 15/587,710

(22) Filed: May 5, 2017

(51) Int. Cl. B60Q 3/72; F21V 5/04; F21V 9/16; H05B 33/08; B60Q 3/82; B60Q 3/60

(52) U.S. Cl. CPC B60Q 3/72; F21V 5/04; F21V 9/16; F21Y 2115/10; H05B 33/0872; B60Q 3/82; B60Q 3/60; H05B 33/0854

(57) ABSTRACT

A vehicle lamp is provided herein. The vehicle lamp includes a first light source operably coupled with a lens. A switch is configured to control an activation state of the first light source. A controller prompts the first light source to generate a low-intensity light of a first color when a night-like condition is detected and a vehicle is in motion and a high-intensity light of a second color when the vehicle is stationary.

### FIELD OF THE INVENTION

The present disclosure generally relates to vehicle lamp assemblies, and more particularly, to vehicle lamp assemblies that may employ one or more luminescent structures.

### BACKGROUND OF THE INVENTION

Activation of vehicle interior lamps in low light conditions may distract an operator of a vehicle. For some vehicles, it may be desirable to have a lamp that is less distracting upon activation in such conditions.

### SUMMARY OF THE INVENTION

According to one aspect of the present invention, a vehicle lamp is disclosed. The vehicle lamp includes a first light source operably coupled with a lens. A switch is configured to control an activation state of the first light source. A controller prompts the first light source to generate a low-intensity light of a first color when a night-like condition is detected and a vehicle is in motion and a high-intensity light of a second color when the vehicle is stationary.

According to another aspect of the present invention, a vehicle lamp is disclosed. The vehicle lamp includes a light source operably coupled with a lens. A controller prompts the light source to change an illumination state of the light source from a first color to a second color when a vehicle exceeds a predetermined speed and a night-like condition is detected.

According to yet another aspect of the present invention, a lamp for a vehicle is disclosed. The lamp includes a light source operably coupled with a lens. A controller prompts the light source to change an illumination state of the light source from a first color to a second color when a vehicle transmission is placed in a reverse position and a night-like condition is detected.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to some examples;

FIG. 1B is a top view of a luminescent structure rendered as a discrete particle, according to some examples;

FIG. 1C is a side view of a plurality of luminescent structures rendered as discrete particles and incorporated into a separate structure;

FIG. 2 is a schematic diagram illustrating a front occupant compartment of a vehicle having an overhead console employing two lamps, according to some examples;

FIG. 3 is a top plan view of the vehicle having a plurality of lamps, according to various examples;

FIG. 4 is a side perspective view of the vehicle having the overhead console and a rearwardly disposed lamp, according to some examples;

FIG. 5 is a schematic diagram illustrating the lamp employing a capacitive sensing configuration, according to some examples;

FIG. 6 is a block diagram of the lamp, according to some examples;

FIG. 7 is a block diagram of the lamp, according to some examples;

FIG. 8 is a block diagram of the lamp including the luminescent structure, according to some examples; and

FIG. 9 is a flow diagram illustrating a routine for controlling the lamp, according to some examples.

### DETAILED DESCRIPTION OF THE PREFERRED EXAMPLES

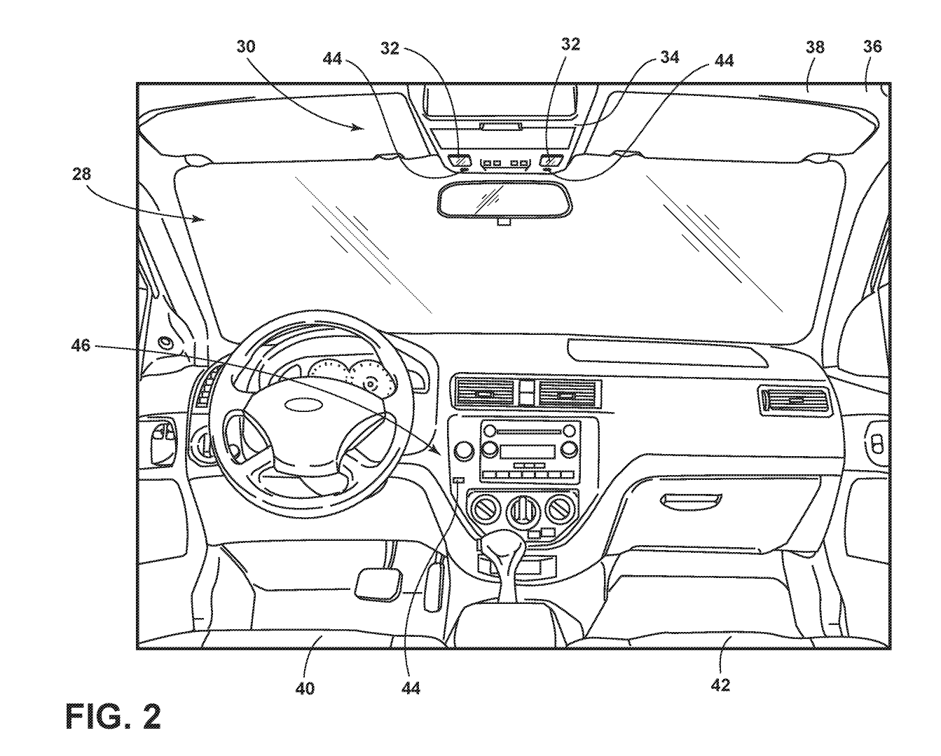

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a lamp for a vehicle. The lamp may emit light in various color spectrums and at varying intensities based on a wide range of predefined events. The lamp may further employ one or more phosphorescent and/or luminescent structures to luminesce in response to predefined events. The one or more luminescent structures may be configured to convert excitation light received from an associated light source and re-emit the light at a different wavelength generally found in the visible spectrum.

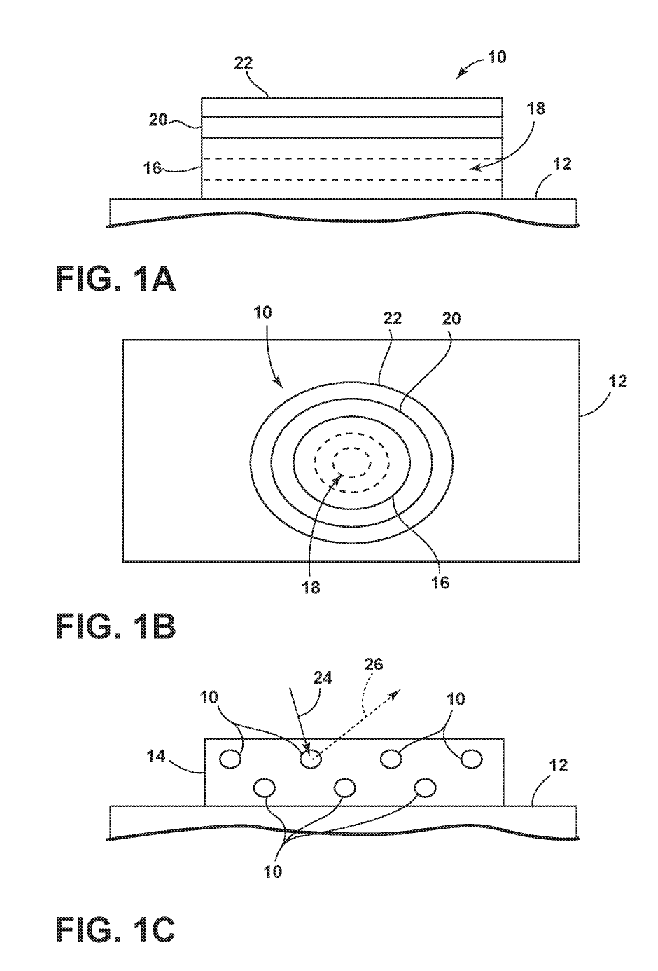

Referring to FIGS. 1A-1C, various exemplary examples of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer-wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG: Ce and may be a short-persistence luminescent material 18. For example, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue excitation light 24 emitted from the light sources 66. According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material known in the art may be utilized without departing from the teachings provided herein.

Additionally, or alternatively, the luminescent material 18, according to various examples, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light sources 66). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any light sources 66 that emit the excitation light 24, including, but not limited to, natural light sources (e.g., the sun) and/or any artificial light sources 66. The periodic absorption of the excitation light 24 from any excitation source may provide for a substantially sustained charge of the long-persistence luminescent material 18 to provide for consistent passive illumination. In various examples, a light-detecting device 68 may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for example, doped di-silicates, or any other compound that is capable of emitting light for a period of time once the excitation light 24 is no longer present. The long-persistence luminescent material 18 may be doped with one or more ions, which may correspond to rare earth elements, for example, Eu2+, Tb3+, and/or Dy3. According to one non-limiting exemplary example, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting exemplary example, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

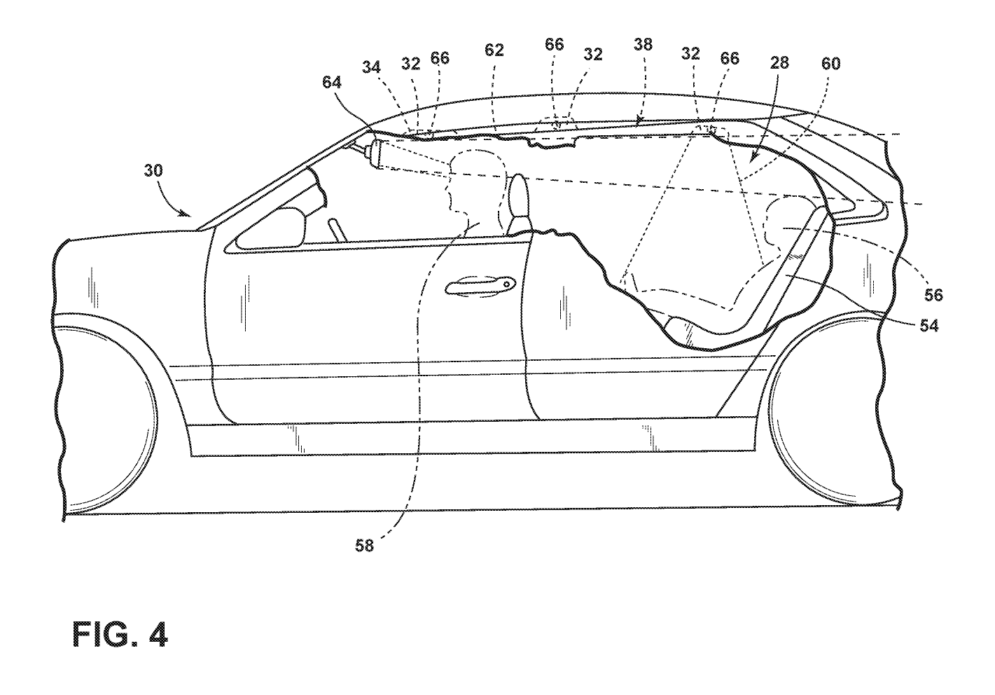

Referring to FIG. 2, a vehicle occupant compartment 28 of a vehicle 30 is generally illustrated having at least one lamp 32 assembled in an overhead console 34. In the illustrated example, the overhead console 34 is assembled to an interior side 36 of a headliner 38 of the vehicle occupant compartment 28 and positioned in a central location in a lateral direction (vehicle side-to-side) in the vehicle occupant compartment 28. As exemplarily shown, two lamps 32 are assembled to the overhead console 34, one positioned to provide greater access to a driver 58 (FIG. 4) positioned in a driver's seat 40, and the other positioned to provide greater access to an occupant 56 (FIG. 4) seated in a front vehicle occupant seat 42. While two lamps 32 have generally been shown in FIG. 2, it should be appreciated that one or more lamps 32 can be assembled at other locations of the overhead console 34 or other locations on board the vehicle 30. Additionally, one or more switches 44 can be provided to allow a vehicle occupant 56 to manually activate the lamps 32. As exemplarily shown, a switch 44 is located proximate to each corresponding lamp 32 to allow each lamp 32 to be independently controlled. Additionally or alternatively, one or more switches 44 can be located elsewhere on board the vehicle 30, such as on and/or within a vehicle cockpit module 46, as exemplarily shown in FIG. 2. However, it should be appreciated that the switch 44 can be located in other locations inside the vehicle 30 such as, but not limited to, a driver side door, an occupant side door, and/or a center console area.

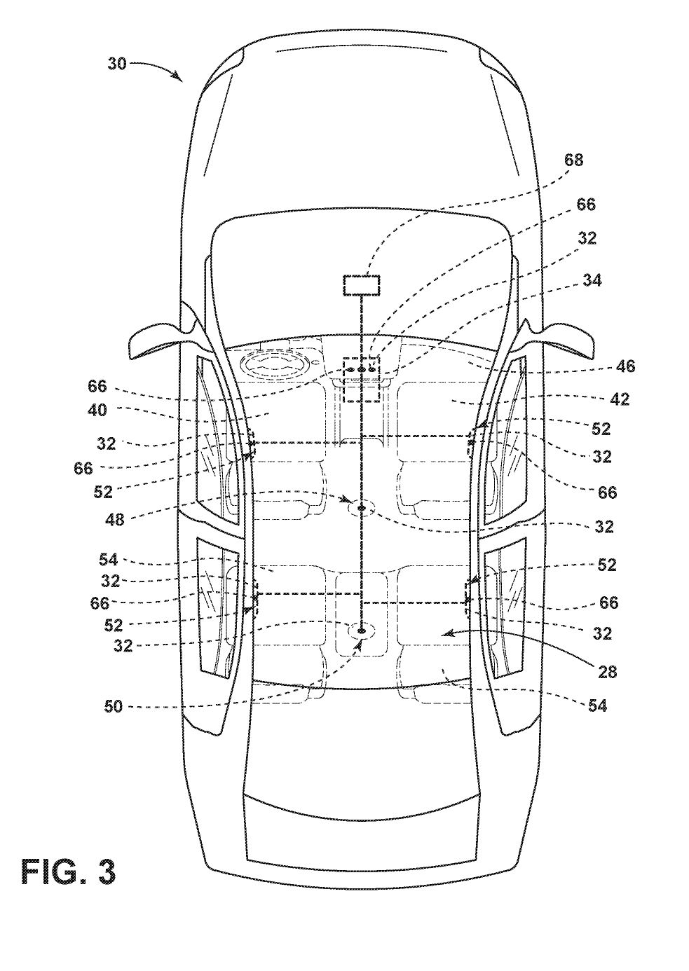

Referring to FIGS. 3 and 4, the vehicle 30 may include a plurality of lamps 32 in conjunction with, or in lieu of, the overhead console. For example, as illustrated in FIG. 3, the vehicle 30 may include the overhead console having lamps 32 therein, a central lamp 48, and a rear lamp 50. Additionally, and/or alternatively, the vehicle 30 may include outwardly disposed lamps 52 positioned over, and/or in close proximity to, one or more front seats 40, 42 and/or rear seats 54 disposed within the vehicle 30. The lamps 32 may be utilized for a wide variety of purposes, including but not limited to, task lighting, feature lighting, ambient lighting, and/or notification lighting.

Referring to FIG. 4, a driver 58 may be positioned in the driver's seat 40 and the rear seat 54 may seat an occupant 56. When the central lamp 48 and/or the rear lamp 50 are activated, light 60 emitted therefrom may be within a field of view 62 of the driver 58. The emitted light 60 may enter the field of view 62 of the driver 58 through direct transmission to the driver 58 or through indirect transmission. For example, the light 60 may directly transmit to the driver 58 when the driver 58 is looking rearwardly. Indirect transmission may occur through light 60 that is reflected off any other surface within the vehicle 30, such as a mirror assembly 64.

With further reference to FIGS. 3 and 4, the rods within a human eye play a major role in visual acuity, especially in low light situations. Even though the eye can be most sensitive to cyan light or any other high radiance light when a person is dark-adapted (scotopic zone), exposure to high radiance light (any visible spectral range light, and especially cyan light where the rods are sensitive) can quickly reduce the sensitivity of the eyes' rods because the rods can virtually shut down for 10-25 minutes after bright light exposure and night vision can be significantly reduced.

Accordingly, the lamps 32 provided herein may illuminate in a first color (e.g., red) once activated to preserve scotopic or mesopic visual acuity relative to most other broad light spectrum illumination approaches. Moreover, the switch 44 may provide various activations of one or more light sources 66 within the lamps 32 that may illuminate at a first, lower intensity upon a first switch activation. Upon a second switch activation, the lamps 32 may illuminate in the first color at a second, higher intensity. Upon an additional activation, the lamps 32 may illuminate in a second color (e.g., white) that may include high radiance light. Upon further activations, various intensities may be output from the lamp until a final switch activation returns the lamp 32 to an unilluminated state.

Referring still to FIGS. 3 and 4, in some examples, when any of the lamps 32 are activated, the lamps 32 within the overhead console may emit light of the first color to wash out the light emitted from the other lamps 32 from the field of view 62 of the driver 58. By washing out the light emitted from other lamps 32, the overhead console may assist in preserving the sensitivity of the eyes' rods in low light conditions.

In some examples, the vehicle 30 includes a light-detecting device 68 (FIG. 3) that may be utilized for varying the intensity of light 26 emitted from the lamp 32. The light-detecting device 68 senses the environmental lighting conditions, such as whether the vehicle 30 is in day-like conditions (i.e., higher light level conditions) and/or whether the vehicle 30 is in night-like conditions (i.e., lower light level conditions). The light-detecting device 68 can be of any suitable type and can detect the day-like and night-like conditions in any suitable fashion. For instance, in some examples, the light-detecting device 68 includes a light sensor that detects the amount of light (e.g., solar radiation) affecting the vehicle 30 for determining whether day-like or night-like conditions exist. According to some examples, the colors of light and/or intensities of light emitted from the lamps 32 may be varied based on the sensed conditions. For example, the lamps 32 may emit light of high intensity in any color during day-like conditions. Additionally, and/or alternatively, the lamps 32 may be configured to emit light of the first color and low intensity in the second color in night-like conditions while the vehicle 30 is in motion. Once the vehicle 30 is in a parked state, the lamps 32 may emit light in a high intensity in the second color.

According to some examples, each lamp 32 may dim and change from the second color to the first when the vehicle transmission is placed in reverse, when the vehicle 30 is placed in drive, when the vehicle 30 exceeds a predefined speed (e.g., three miles per hour), etc. As provided herein, the dimming may occur when night-like conditions are sensed, and the initial intensity may be maintained while day-like conditions are sensed. The lamps 32 may illuminate in a wide range of colors to provide notifications as well. For example, while the vehicle 30 is in motion if a door is opened, the lamps 32 may illuminate in the first color to provide a warning notification.

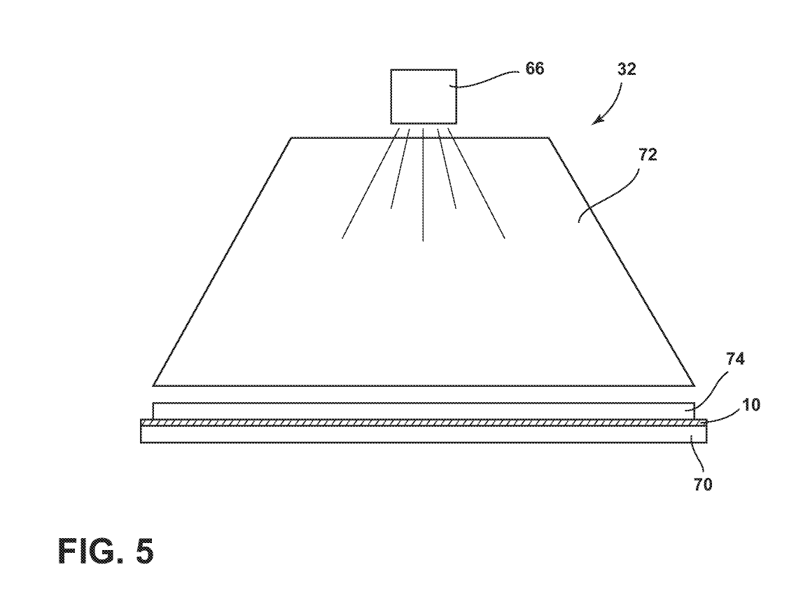

Referring to FIG. 5, a diagram of the lamp 32 is shown, according to some examples. The lamp 32 includes a lens 70 that is accessible by vehicle occupants 56 and a light source 66 for illuminating the lens 70. The light source 66 is generally provided behind the lens 70 and may be configured to emit visible and/or non-visible light, such as blue light, ultraviolet (UV) light, infrared light, and/or violet light and may include any form of light source 66. For example, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the lamp 32. Further, various types of LEDs are suitable for use as the light sources 66 including, but not limited to, top-emitting LEDs, side-emitting LEDs, and others.

To disperse the light emitted from the light source 66, a diffusing optic 72 can be disposed between the light source 66 and the lens 70 to provide for a more even light distribution across the lens 70 when the light source 66 is activated. Activation of the light source 66 can be achieved in a variety of ways. For instance, in some examples, the lens 70 can be implemented in a push configuration, whereby a vehicle occupant 56 presses or pushes the lens 70 inward to activate the light source 66. Additionally or alternatively, the light source 66 can be activated via a corresponding switch 44 on board the vehicle 30, as previously described.

In the illustrated example, the switch 44 is configured as a proximity sensor, shown and described herein as capacitive sensor 74 can be provided behind the lens 70 and coupled thereto. The capacitive sensor 74 provides a sense activation field that encompasses the outermost surface of the lens 70 and can detect capacitive changes resulting from a conductor, such as a vehicle occupant's finger, being within the sense activation field of the capacitive sensor 74 (e.g. touching the lens 70). In some examples, if the capacitive change meets or exceeds a predetermined threshold level, the light source 66 can be prompted to activate accordingly. While the proximity sensor is shown and described herein as capacitive sensor 74, it should be appreciated that additional or alternative types of proximity sensors can be used for detecting various other signal changes, such as, but not limited to, inductive sensors, optical sensors, temperature sensors, resistive sensors, the like, or a combination thereof.

With further reference to FIG. 5, a luminescent structure 10 may be disposed on and/or within the lens 70. In operation, the luminescent structure 10 receives the excitation light 24 and, in response, luminesces therefrom. The luminescent structure 10 may contain a short-persistence luminescent material 18 such that the luminescent structure 10 quickly ceases to luminesce after the excitation light 24 is no longer present. According to some examples, the luminescent structure 10 may emit converted light in the red spectrum.

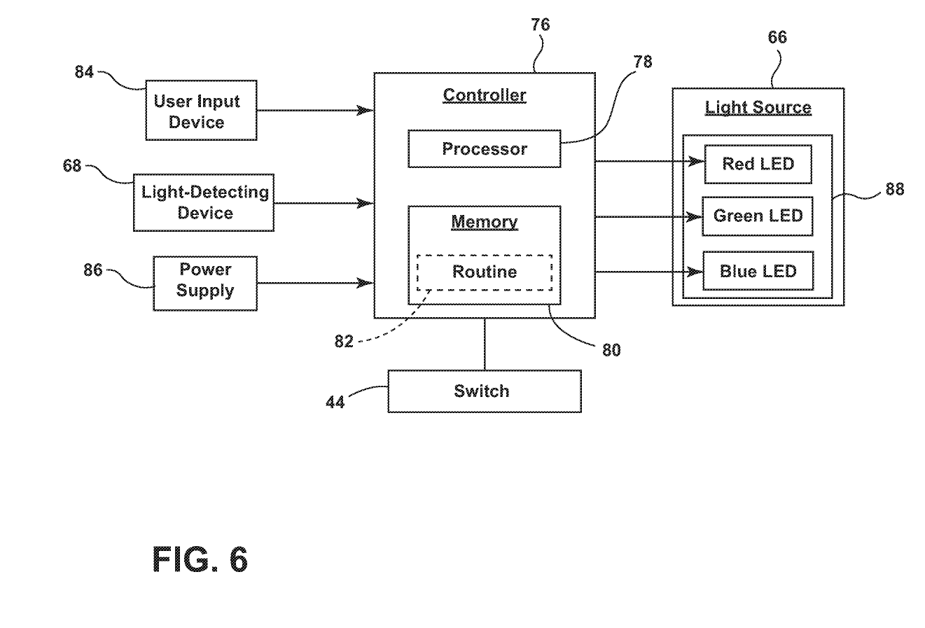

Referring to FIGS. 6-8, the lamp 32 can further include a controller 76 in electrical communication with the switch 44 and the light source 66. In this configuration, when the switch 44 is toggled, the controller 76 can respond by activating/deactivating the light source 66 accordingly. As shown, the controller 76 can include circuitry such as a processor 78 and memory 80. According to some examples, a routine 82 for controlling the lamp 32 is stored in the memory 80 and is executed by the processor 78. Additionally, the controller 76 can receive input from one or more user input devices 84 and/or one or more vehicle equipment, shown as the light-detecting device 68 configured to detect the presence of a night-like condition. To drive the light source 66, the controller 76 can be supplied electrical power from a power supply 86, which can be an onboard vehicle power supply or an independent power supply.

The controller 76 is configured to prompt the light source 66 to generate a low-intensity light in night-like conditions. Further, the aforementioned feature can be implemented autonomously and/or manually induced. In some examples, the controller 76 can receive input from the light-detecting device 68, indicating the presence of a night-like condition, at which point the controller 76 prompts the light source 66 to generate the low-intensity light. The low-intensity light can be expressed as a faint glow (e.g. ambient lighting) so as to enhance a driving experience without distracting the driver 58. Additionally or alternatively, the light source 66 can be manually activated using the switch 44. In any event, by providing a lamp 32 equipped with the low-intensity light feature, vehicle occupants 56 can visually locate the many items during night-like conditions while preserving their scotopic or mesopic vision.

Each light intensity setting can be expressed as a light of the same color or a different color and can be selected by a vehicle occupant 56 using any suitable user input device 84 (e.g. the vehicle cockpit module 46). For example, the occupant 56 can override the first color/second color transition causing each of the lamps 32 to illuminate in any desired color at any desired intensity upon activation thereof. The driver 58 may also determine the time between switch activations, the actuation of each lamp 32, the utilization of the light-detecting device 68 in conjunction with the lamps 32, etc.

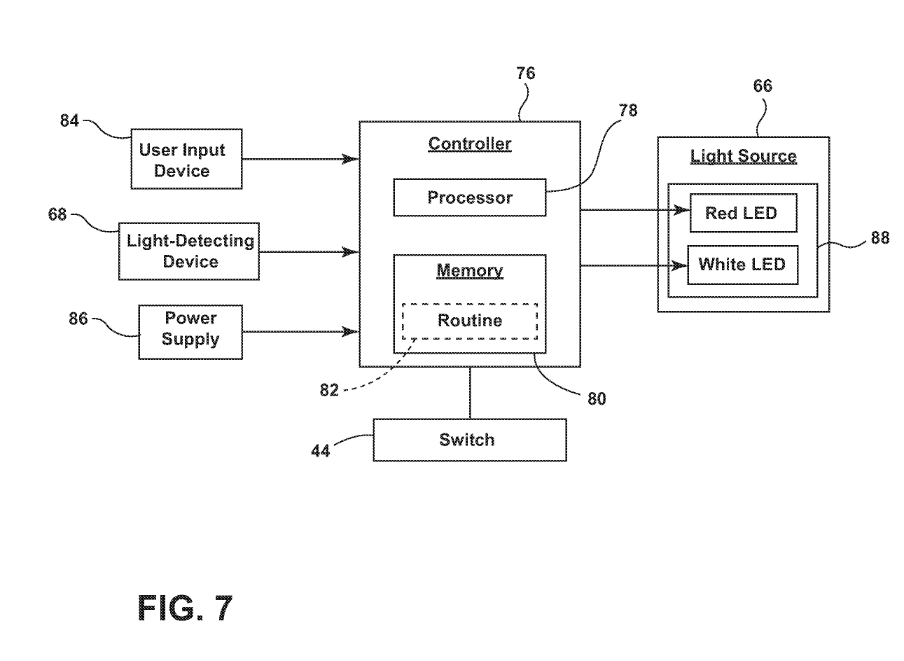

In some examples, the first color, which may be emitted at a low intensity and a high intensity may be in the red color spectrum while the second color of light can be expressed as light in the white spectrum. As is further shown in FIG. 6, according to some examples, the light source 66 can include a LED package 88 having red, green, and blue light emitting diodes, whereby a red LED provides the low intensity and high intensity red light and a combination of the red, green, and blue LEDs provides the low and high-intensity white light. Alternatively, as shown in FIG. 7, the LED package 88 can have a red LED for providing the low and high-intensity red light and a white LED for providing the low and high-intensity white light. In either example, the controller 76 can provide each LED with generated pulse width modulated (PWM) signals to produce the corresponding light intensity and light color. Alternatively, the controller 76 can directly drive the current to each LED to accomplish the same.

Referring still to FIGS. 6-8, according to some examples, the time, date, global vehicle position, etc. may be utilized for determining the settings of the lamp 32. For example, depending on the time of year and global vehicle position, the lamp 32 may determine expected sunlight values, and day or night, independent of external lighting levels. Based on this data, a look-up table may be utilized to determine if the lamps 32 should illuminate initially in the first color or the second and at a high or low intensity.

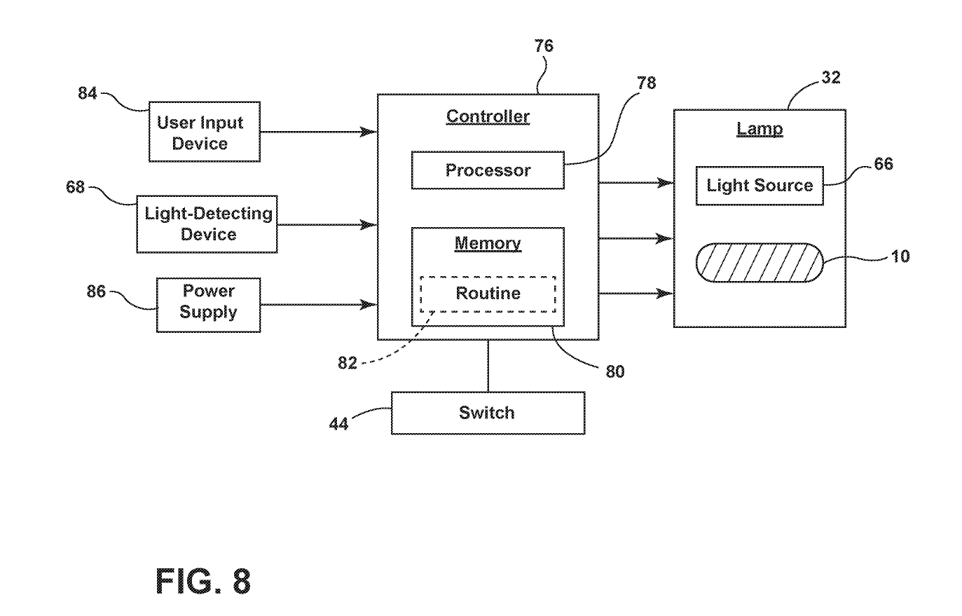

Referring to FIG. 8, the luminescent structure 10 may be optically coupled with one or more light sources 66 within the lamp 32 or disposed proximately to the lamp 32. In operation, the luminescent structure 10 may include a plurality of luminescent materials 18 therein that luminesce in response to receiving light of a specific wavelength spectrum. According to various examples, the luminescent structure 10 discussed herein is substantially Lambertian; that is, the apparent brightness of the luminescent structure 10 is substantially constant regardless of an observer's angle of view. As described herein, the color of the converted light 26 may be dependent on the particular luminescent materials 18 utilized in the luminescent structure 10. Additionally, a conversion capacity of the luminescent structure 10 may be dependent on a concentration of the luminescent material 18 utilized in the luminescent structure 10. By adjusting the range of intensities that may excite the luminescent structure 10, the concentration, types, and proportions of the luminescent materials 18 in the luminescent structure 10 discussed herein may be operable to generate a range of color hues of the excitation light 24 by blending the first wavelength with the second wavelength.

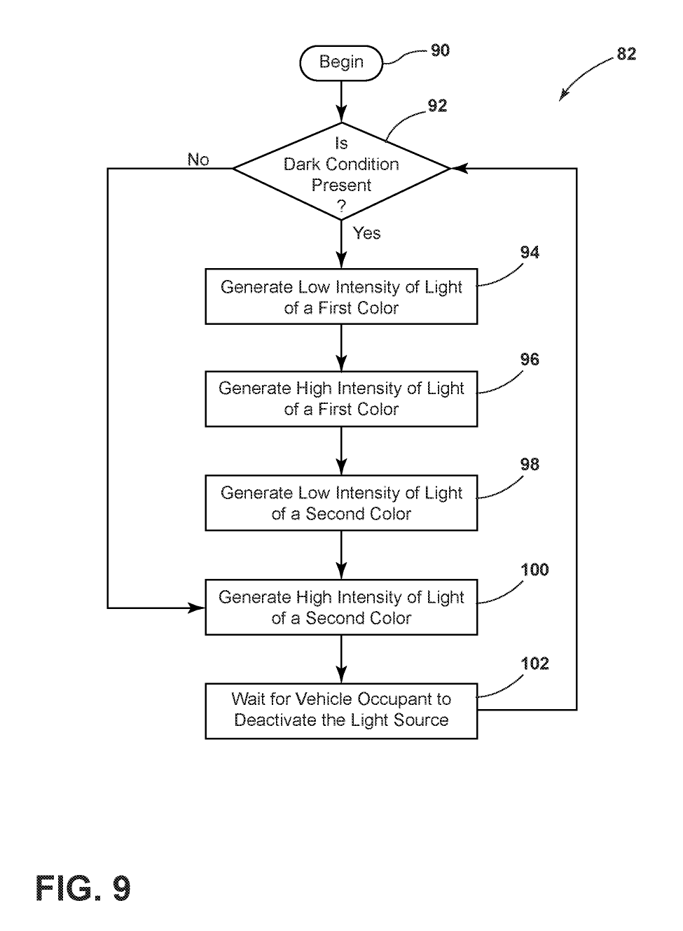

Referring to FIG. 9, the routine 82 for controlling the lamp 32 is illustrated, according to some examples. The routine 82 begins at step 90 and, once the switch 44 is activated, proceeds to step 92 to check if a night-like condition is present. As described previously, the controller 76 can receive a signal from the light-detecting device 68 indicating the presence of a night-like condition. If a night-like condition is present, the routine 82 proceeds to step 94, where the controller 76 prompts the lamp 32 to generate a low-intensity light of a first color when the switch 44 is activated. If a night-like condition is not present, the routine 82 jumps to step 100 when the switch 44 is activated. If the switch 44 is activated again, the routine 82 proceeds to step 96, where the controller 76 prompts the lamp 32 to generate a high-intensity light in the first color. If the switch 44 is activated once again, the lamp 32 may generate light of a second color at a low intensity at step 98. If the switch 44 is activated once again, the lamp 32 may generate light of the second color at a high intensity at step 100. Lastly, at step 102, the lamp 32 waits for a vehicle occupant 56 to deactivate the lamp 32 thereby returning the lamp 32 to an unilluminated state.

For a lamp 32 employing a capacitive sensing configuration, the lamp 32 can be deactivated when the capacitive sensor 74 detects a capacitive change while the lamp 32 is emitting high-intensity light. Once the lamp 32 has been deactivated, the routine 82 returns to step 92. With respect to the abovementioned routine 82, it should be appreciated that the first color and the second color can be the same color or a different color and as described previously, the lamp 32 can include one or more LEDs depending on the desired color to be emitted therefrom.

Each switch activation provided herein may be an independent, sequential activation of the switch 44 that controls each lamp 32. Additionally, and/or alternatively, the user may maintain an activation signal for a period of time causing the lamps 32 to illuminate in the various patterns. Once the switch 44 is released, the lamp 32 may maintain the illumination pattern that is presently exhibited when the switch 44 is released. For example, once the switch 44 is activated, the lamp 32 may illuminate in the first color at a first intensity. Next, if the switch 44 is still activated for a period of time, the lamp 32 may illuminate in the first color at a high intensity. Next, if the switch 44 is still activated for a period of time, the lamp 32 may illuminate in the second color at a low intensity. Next, if the switch 44 is still activated for a period of time, the lamp 32 may illuminate in the second color at a high intensity. If at any point during the sequence the switch 44 is released, the lamp 32 may continue to illuminate in the pattern exhibited when the switch 44 was released.

Accordingly, a vehicle lamp 32 and method of controlling the same has been advantageously provided herein. The lamp 32 includes a light source 66 that is capable of being manually or automatically activated to generate a low-intensity light to illuminate the lens 70 of the lamp 32. As a result, the lamps 32 provided herein may preserve scotopic or mesopic visual acuity relative to most other broad light spectrum illumination approaches. The lamps 32 provided herein may also provide additional aesthetic detail to the vehicle 30 thereby increasing the safety of the vehicle 30 and/or the perceived value of the vehicle 30. The lamps 32 may be manufactured at low costs when compared to standard vehicle light assemblies.

According to various examples, a vehicle lamp is provided herein. The vehicle lamp includes a first light source operably coupled with a lens. A switch is configured to control an activation state of the first light source. A controller prompts the first light source to generate a low-intensity light of a first color when a night-like condition is detected and a vehicle is in motion and a high-intensity light of a second color when the vehicle is stationary. Examples of the vehicle lamp can include any one or a combination of the following features:
a controller configured to activate the light source based on a plurality of inputs;
a luminescent structure disposed between the first light source and lens and configured to luminesce in response to receiving an excitation light from the first light source;
the first light source comprises a red light emitting diode, a green light emitting diode, and a blue light emitting diode;
the first light source comprises a red light emitting diode and a white light emitting diode;
the first color is a red color and the second color is a white color;
a diffusing optic disposed between the first light source and the lens;
the low-intensity light is implemented by one of a first pulse width modulation and a first direct drive current and the high-intensity light is implemented by one of a second pulse width modulation and a second direct drive current;
a second light source, wherein the first light source is disposed within a vehicle overhead center console and the second light source is disposed rearwardly of the first light source;
the first light source emits a first color of light when the second light source emits a second color of light;
the first light source emits a first color of light when the second light source emits a second color of light;
the controller receives an input from a vehicle light-detecting device indicating a presence of a night-like condition;
the switch is configured as a capacitive sensor operably coupled with the light source and configured to provide the switch activation state to the controller when a capacitive change is detected across the capacitive sensor;
the low-intensity light is provided by the red LED and the high-intensity light is provided by the red, green, and blue LEDs and is expressed as a color mixture of red, green, and blue light; and/or
the various intensities and colors of light are sequentially emitted as the switch activation is maintained.

Moreover, the lamp may be manufactured by positioning a first light source operably coupled with a lens within a vehicle; providing a switch configured to control an activation state of the first light source; and coupling a controller to the light source that prompts the first light source to generate a low-intensity light of a first color when a night-like condition is detected and a vehicle is in motion and a high-intensity light of a second color when the vehicle is stationary.

It will be understood by one having ordinary skill in the art that construction of the described invention and other components is not limited to any specific material. Other exemplary examples of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures, members, connectors, and/or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A vehicle lamp, comprising:
a first light source operably coupled with a lens and disposed proximate a headliner;
a switch configured to control an activation state of the first light source;
a transmission configured to control movement of a vehicle; and
a controller for prompting the first light source to generate a low-intensity light of a first color when a night-like condition is detected and the vehicle is in motion as detected by the transmission and a high-intensity light of a second color when the transmission is in a stationary condition.

2. The lamp of claim 1, further comprising:
a luminescent structure disposed between the first light source and lens and configured to luminesce in response to receiving an excitation light from the first light source.

3. The lamp of claim 1, wherein the first light source comprises a red light emitting diode, a green light emitting diode, and a blue light emitting diode.

4. The lamp of claim 1, wherein the first light source comprises a red light emitting diode and a white light emitting diode.

5. The lamp of claim 1, wherein the first color is a red color and the second color is a white color.

6. The lamp of claim 1, further comprising:
a diffusing optic disposed between the first light source and the lens.

7. The lamp of claim 1, wherein the low-intensity light is implemented by one of a first pulse width modulation and a first direct drive current and the high-intensity light is implemented by one of a second pulse width modulation and a second direct drive current.

8. The lamp of claim 1, wherein the controller receives an input from a vehicle light-detecting device indicating a presence of a night-like condition.

9. The lamp of claim 1, further comprising:
a second light source, wherein the first light source is disposed within a vehicle overhead center console and the second light source is disposed rearwardly of the first light source.

10. The lamp of claim 9, wherein the first light source washes out the light emitted from the second light source to preserve the sensitivity of rods of a user's eye in low light conditions.

11. The lamp of claim 10, wherein the first color of light is in the red spectrum and the second color of light is in a non-red spectrum.

12. A vehicle lamp, comprising:
a light source operably coupled with a lens;
a speed-measuring device;
a light-detecting device forwardly of the light source; and
a controller for changing an illumination state of the light source from a light in a white spectrum to a light in a red color spectrum when the speed-measuring device detects a vehicle exceeding a predetermined speed and a night-like condition is detected by the light-detecting device.

13. The vehicle lamp of claim 12, further comprising:
a capacitive sensor operably coupled with the light source and configured to provide a switch activation state to the controller when a capacitive change is detected across the capacitive sensor.

14. The vehicle lamp of claim 12, wherein the light source is disposed within an overhead console and emits the light in a red color spectrum to wash out a light emitted from an additional light source from a field of view of a driver.

15. The vehicle lamp of claim 12, wherein the light source comprises a red LED, a green LED, and a blue LED, wherein a low-intensity light is provided by the red LED and a high-intensity light is provided by the red, green, and blue LEDs and is expressed as a color mixture of red, green, and blue light.

16. A lamp for a vehicle, comprising:
a first light source disposed within an overhead console;
a second light source disposed further from a driver's seat than the first light source; and
a controller for prompting the first light source to emanate light in a red spectrum when a vehicle transmission is in use, a night-like condition is detected by a light-detecting device, and the second light source is activated.

17. The lamp for a vehicle of claim 16, further comprising:
a switch configured to control an activation state of the light source, wherein the controller illuminates the light source between various intensities and colors as sequential switch activations occur.

18. The lamp for a vehicle of claim 17, wherein the various intensities and colors of light are sequentially emitted as a switch activation is maintained.

19. The lamp for a vehicle of claim 16, further comprising:
a luminescent structure disposed between the light source and lens and configured to luminesce in response to receiving an excitation light from the light source.

20. (canceled)

21. The lamp for a vehicle of claim 16, wherein the first light source washes out the light emitted from the second light source to preserve the sensitivity of rods of a user's eye in low light conditions.
